(19) United States
(12) Patent Application Publication
(10) Pub. No.: US 2015/0146098 A1
(43) Pub. Date: May 28, 2015

(54) DISPLAY DEVICE

(71) Applicant: SHARP KABUSHIKI KAISHA, Osaka-shi, Osaka (JP)

(72) Inventor: Takashi Kanda, Osaka-shi (JP)

(73) Assignee: SHARP KABUSHIKI KAISHA, Osaka-shi, Osaka (JP)

(21) Appl. No.: 14/415,974

(22) PCT Filed: Jul. 16, 2013
(86) PCT No.: PCT/JP2013/069290

§ 371 Date: Jan. 20, 2015

(30) Foreign Application Priority Data
Jul. 20, 2012 (JP) 2012-161273
Jul. 11, 2013 (JP) 2013-145487

(51) Int. Cl. H04N 9/87; H04N 9/64

(52) U.S. Cl. CPC H04N 9/87; H04N 9/64
USPC 348/453

(57) ABSTRACT

The objective of the present invention is to provide a display device which, when transforming three primary colors of input to four primary colors of output and displaying the same, is capable of performing accurate color reproduction using a simple method. A display device is provided with a color transformation portion (12) which transforms 3 RGB primary colors of an input video image signal into a tri-stimulus value of an XYZ color system, and transforms the transformed tri-stimulus value to 4 primary colors of an output video image signal. The color transformation portion (12) fixes at least one color component among any of the 4 primary colors of the output video image signal, obtains a tri-stimulus value difference which is a difference between the tri-stimulus value of the 3 RGB primary colors of the input video image signal and the tri-stimulus value of the fixed color component, and transforms the obtained tri-stimulus value difference by way of a predefined inverse matrix to the three color components other than the fixed color component.

### TECHNICAL FIELD

The present invention relates to a display device, and more particularly relates to a display device compatible with multi-primary color display of RGBY, RGBW, or the like.

### BACKGROUND OF THE INVENTION

Conventionally, as display means for displaying information or a video, various displays which form an image with pixels have been commercialized. Common one is that, for example, one pixel is configured by sub-pixels (sub pixels) of three primary colors composed of red (R), green (G) and blue (B), to thereby perform color display. For realizing these sub-pixels, a color filter is usually used. In such a technology of color display, a so-called multi-primary color display has been developed, which is capable of expanding an area on a chromaticity diagram (in the case of a chromatic color) and improving luminance efficiency (in the case of white) by using a new color other than three primary colors to increase the number of primary colors to four or more primary colors.

In the multi-primary color display above, wide gamut display which is more efficient than a case of three primary colors is able to be realized by using four or more primary colors, but increasing primary colors causes a problem that flexibility of color transformation occurs. That is, in an existing three-primary color display, since tri-stimulus values XYZ of a color and three primary colors RGB have a relation of three to three, there is no flexibility in transformation and unique mutual transformation is possible, but, against this, for example, in the case of four primary colors, tri-stimulus values XYZ and four primary colors have a relation of three to four, resulting that flexibility occurs in transformation between the tri-stimulus values and gray level values of respective primary colors and unique transformation is not be able to be performed. This shows that there are more than one combinations of primary colors for displaying certain tri-stimulus values XYZ.

Against this, for example, Patent Literature 1 discloses a color transforming device capable of reproducing image data corresponding to input white appropriately when performing color transformation into multi-primary colors. According to this, by utilizing that three-dimension gamut of multi-primary color (N-primary color) display becomes an N (N−1) polyhedron, when a quadrangular pyramid is segmented from this polyhedron, it is possible to represent the segmented quadrangular pyramid with three vectors. At this time, tri-stimulus values XYZ representing a color of an inner side of the quadrangular pyramid is expressed by using three vectors, and multi-primary color gray level is calculated from the three vectors and gray level of a vertex of the quadrangular pyramid.

### PRIOR ART DOCUMENT

### Patent Document

Patent Document 1: Japanese Laid-Open Patent Publication No. 2007-134752

### SUMMARY OF THE INVENTION

### Problem to be Solved by the Invention

However, in the technology described in Patent Literature 1 above, close classification is required as to in which segmented quadrangular pyramid a color desired to be transformed is included, so that complicated calculation needs to be performed. In this manner, in conventional technologies including the technology described in Patent Literature 1, processing is made complicated for performing accurate color reproduction with multi-primary color transformation, and a more simple method of transformation has been desired.

The present invention has been made in view of circumstances as described above, and an object thereof is to provide a display device which is capable of performing accurate color reproduction with a simple method, when transforming three primary colors of input into four primary colors of output to display.

### Means for Solving the Problem

To solve the above problems, a first technical means of the present invention is a display device which transforms an input video signal of RGB three primary colors composed of red, green and blue into an output video signal of four primary colors to display, comprising: a color transformation portion which transforms the RGB three primary colors of the input video signal into tri-stimulus values of an XYZ color system and transforms the transformed tri-stimulus values into the four primary colors of the output video signal, wherein the color transformation portion fixes any one of color components of the four primary colors of the output video signal as well as obtains tri-stimulus value differences which are differences between the tri-stimulus values of the RGB three primary colors of the input video signal and tri-stimulus values of the fixed color component, and transforms the obtained tri-stimulus value differences by a predefined inverse matrix into three color components other than the fixed color component.

A second technical means is the display device of the first technical means, wherein the predefined inverse matrix is an inverse matrix of a 3×3 matrix composed of tri-stimulus values of the three primary colors excluding the fixed color component from the four primary colors of the output video signal.

A third technical means is the display device of the first or the second technical means, wherein, in a case where any one of color components of the RGB three primary colors of the output video signal is fixed, a gray level value of the fixed color component of the output video signal is a value obtained by multiplying a gray level value of a same color component of the input video signal by a predetermined coefficient a (a>0).

A fourth technical means is the display device of the third technical means, wherein the four primary colors of the output video signal are RGBY four primary colors composed of red, green, blue and yellow.

A fifth technical means is the display device of the fourth technical means, wherein the color transformation portion fixes red or green of the output video signal.

A sixth technical means is the display device of the fifth technical means, wherein, in a case where a gray level value of red of the input video signal is larger than a gray level value of green, the color transformation portion fixes red of the output video signal.

A seventh technical means is the display device of the fifth technical means, wherein, in a case where a gray level value of red of the input video signal is equal to or less than a gray level value of green, the color transformation portion fixes green of the output video signal.

An eighth technical means is the display device of the fifth technical means, wherein the color transformation portion judges which of a gray level value of red and a gray level value of green of the input video signal is larger for each frame of the input video signal, and based on a judgment result, fixes red or green for each frame of the output video signal.

A ninth technical means is the display device of the fifth technical means, wherein a scene change judging portion which judges scene change based on a feature amount of the input video signal is included, and the color transformation portion judges which of a gray level value of red and a gray level value of green of the input video signal is larger as to a head frame in which scene change is judged by the scene change judging portion and keeps red or green fixed based on a judgment result until next scene change occurs.

A tenth technical means is the display device of the third technical means, wherein the four primary colors of the output video signal are RGBC four primary colors composed of red, green, blue and cyan.

An eleventh technical means is the display device of the tenth technical means, wherein the color transformation portion fixes green or blue of the output video signal.

A twelfth technical means is the display device of the eleventh technical means, wherein, in a case where a gray level value of green of the input video signal is larger than a gray level value of blue, the color transformation portion fixes green of the output video signal.

A thirteenth technical means is the display device of the eleventh technical means, wherein, in a case where a gray level value of green of the input video signal is equal to or less than a gray level value of blue, the color transformation portion fixes blue of the output video signal.

A fourteenth technical means is the display device of the first or the second technical means, wherein, in a case where a color component other than the RGB three primary colors of the output video signal is fixed, a gray level value of the fixed color component of the output video signal is a value obtained by multiplying a minimum or maximum gray level value of the RGB three primary colors of the input video signal by a predetermined coefficient a (a>0).

A fifteenth technical means is the display device of the fourteenth technical means, wherein the four primary colors of the output video signal are RGBW four primary colors composed of red, green, blue and white.

A sixteenth technical means is the display device of the fifteenth technical means, wherein the color transformation portion fixes white of the output video signal.

### Effect of the Invention

According to the present invention, since it is possible to fix any one of color components of four primary colors of an output video signal and perform a 3×3 matrix operation with the remaining three colors, accurate color reproduction is able to be performed with a simple method when transforming three primary colors of input into four primary colors of output to display.

### BRIEF DESCRIPTION OF DRAWINGS

FIG. 1 is a block diagram showing a configuration example of a display device according to a first embodiment of the present invention.

FIG. 2 is a diagram schematically showing a configuration example of a display portion.

FIG. 3 is a diagram explaining a processing example of a color transformation portion.

FIG. 4 is a flowchart explaining one example of color transformation processing from RGB into RGBY.

FIG. 5 is a block diagram showing a configuration example of a display device according to a second embodiment of the present invention.

FIG. 6 is diagram showing one example of a video histogram.

FIG. 7 is a diagram explaining one example of a method for determining a fixed color for each scene.

FIG. 8 is a diagram showing one example of a color transformation menu screen.

### PREFERRED EMBODIMENT OF THE INVENTION

Description will hereinafter be given for preferred embodiments according to a display device of the present invention with reference to the accompanying drawings.

### First Embodiment

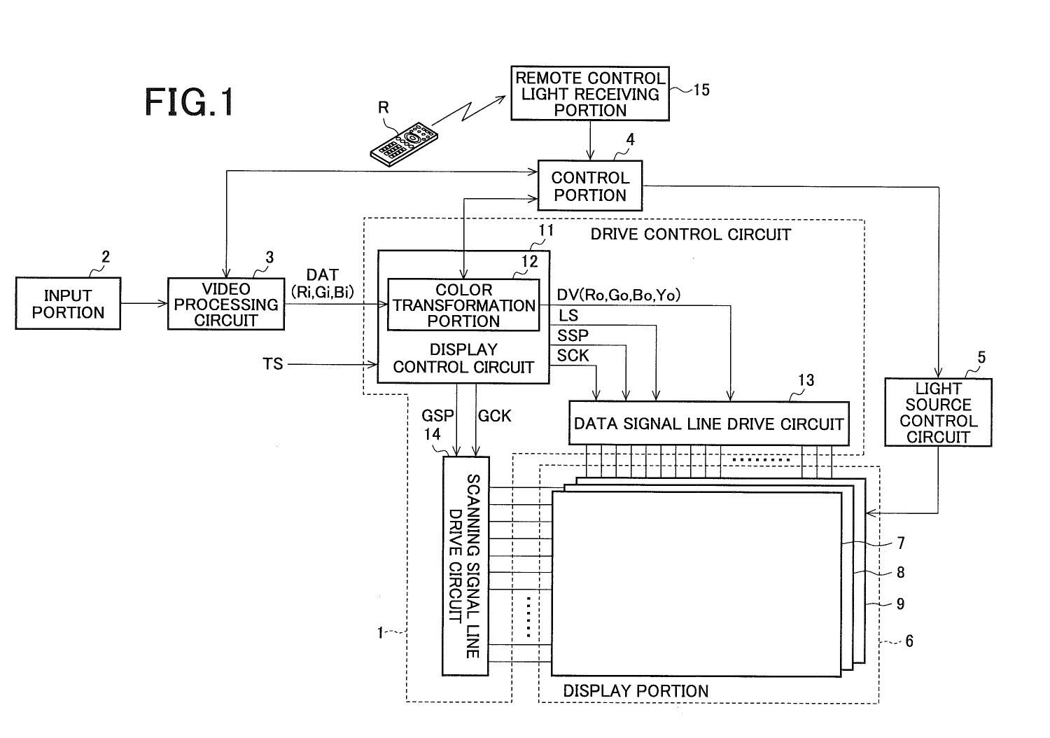

FIG. 1 is a block diagram showing a configuration example of a display device according to a first embodiment of the present invention. As the display device in this example, an RGBY (red, green, blue and yellow) type liquid crystal display device will be exemplified for description, however, displays compatible with other multi-primary colors in an RGBC (red, green, blue and cyan) type, an RGBW (red, green, blue and white) type, and the like also have the same basic configuration. This liquid crystal display device is mainly configured by a drive control circuit 1, an input portion 2, a video processing circuit 3, a control portion 4, a light source control circuit 5, and a display portion 6. The display portion 6 is provided with an active matrix type color display panel, and the drive control circuit 1 generates a driving signal for driving the display portion 6.

The input portion 2 is a tuner that receives a digital broadcast signal to input a video signal included in this digital broadcast signal, or an external interface that connects external equipment such as a game machine, a player or a recorder to input a video signal from the external equipment. This video signal input from the input portion 2 will be referred to as an input video signal below. The video processing circuit 3 is a circuit that executes various signal processing for the input video signal from the input portion 2. The control portion 4 is configured by a CPU, a memory and the like for controlling operations of the liquid crystal display device. The light source control circuit 5 controls electric power supplied to a backlight light source constituting the display portion 6 in accordance with a control command from the control portion 4 to adjust luminance of the backlight light source.

The display portion 6 is configured by a color filter 7, a liquid crystal panel main body 8, and a backlight light source 9. In the liquid crystal panel main body 8, a plurality of data signal lines and a plurality of scanning signal lines intersecting with the plurality of data signal lines are formed. This liquid crystal panel main body 8 and the color filter 7 constitute a color liquid crystal panel including a plurality of pixel forming portions arranged in a matrix state. As the backlight light source 9, for example, an LED (Light Emitting Diode), a cold cathode fluorescent lamp (CCFL), or the like, is considered.

Moreover, the liquid crystal display device is provided with a remote control light receiving portion 15 for receiving a remote control operation signal transmitted from a remote control device R. The remote control light receiving portion 15 is configured by, for example, a light receiving element for receiving the remote control operation signal by infrared ray. The remote control operation signal received by the remote control light receiving portion 15 is input to the control portion 4, and predetermined control is performed in accordance with this remote control operation signal in the control portion 4.

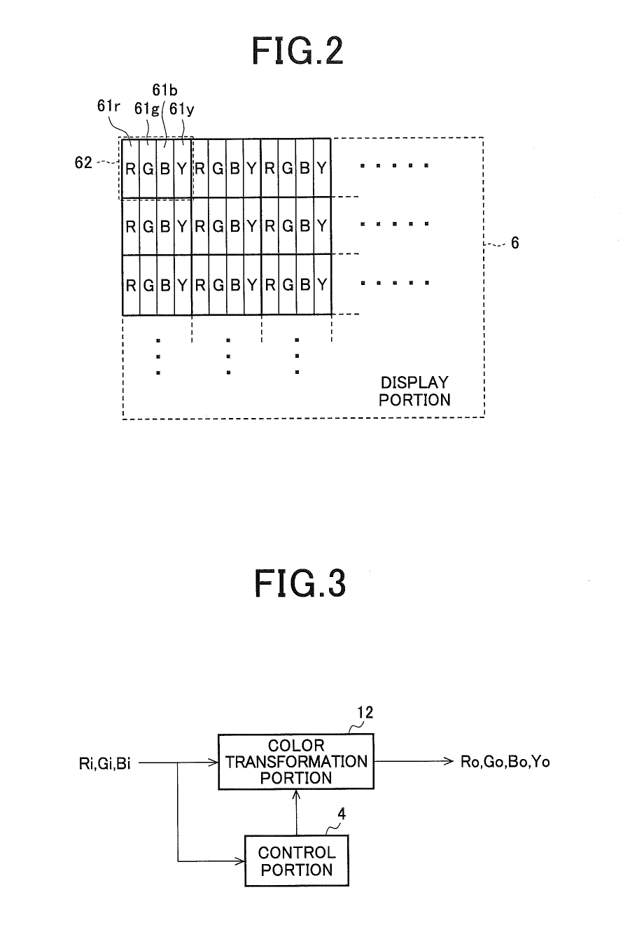

FIG. 2 is a diagram schematically showing a configuration example of the display portion 6. Each pixel forming portion 62 at the display portion 6 is composed of an R sub pixel forming portion 61r, a G sub pixel forming portion 61g, a B sub pixel forming portion 61b, and a Y sub pixel forming portion 61y corresponding to red (R), green (G), blue (B) and yellow (Y), respectively, in which each pixel of a color image displayed by this display portion 6 is composed of an R sub pixel, a G sub pixel, a B sub pixel and a Y sub pixel corresponding to red, green, blue and yellow, respectively. Note that, it is set that this sub pixel has the same meaning as a sub-pixel.

The drive control circuit 1 is provided with a display control circuit 11, a data signal line drive circuit 13, and a scanning signal line drive circuit 14. The display control circuit 11 receives a data signal DAT (Ri, Gi, Bi) from the video processing circuit 3 and a timing control signal TS from a not-shown timing controller, and outputs a digital video signal DV (Ro, Go, Bo, Yo), a data start pulse signal SSP, a data clock signal SCK, a latch strobe signal LS, a gate start pulse signal GSP, a gate clock signal GCK, and the like.

As shown in FIG. 2, each pixel forming portion 62 of the display portion 6 is composed of the R sub pixel forming portion 61r, the G sub pixel forming portion 61g, the B sub pixel forming portion 61b, and the Y sub pixel forming portion 61y corresponding to red, green, blue and yellow, respectively, and the data signal DAT is composed of three primary color signals (Ri, Gi, Bi) corresponding to RGB three primary colors of red, green and blue, respectively. The display control circuit 11 is provided with a color transformation portion 12 that transforms input primary color signals (Ri, Gi, Bi) corresponding to the RGB three primary colors into output primary color signals (Ro, Go, Bo, Yo) corresponding to RGBY four primary colors. The digital video signal DV is the output primary color signal (Ro, Go, Bo, Yo) to be output from the color transformation portion 12, which allows to display a color image to be displayed on the display portion 6.

Further, the above-described data start pulse signal SSP, data clock signal SCK, latch strobe signal LS, gate start pulse signal GSP, gate clock signal GCK and the like are timing signals for controlling timing for displaying an image on the display portion 6.

The data signal line drive circuit 13 receives the digital image signal DV (Ro, Go, Bo, Yo), the data start pulse signal SSP, the data clock signal SCK and the latch strobe signal LS output from the display control circuit 11, and applies data signal voltage as a driving signal to each data signal line for charging pixel capacity in each of the sub pixel forming portions 61r, 61g, 61b and 61y in the display portion 6. At this time, in the data signal line drive circuit 13, the digital video signal DV indicating voltage to be applied to each data signal line is sequentially held at the timing of generating a pulse of the data clock signal SCK. Then, at the timing of generating a pulse of the latch strobe signal LS, the above-described digital video signal DV which is held is transformed into analog voltage to be concurrently applied to all the data signal lines in the display portion 6 as the data signal voltage.

Here, the data signal line drive circuit 13 generates analog voltage corresponding to the primary color signals Ro, Go, Bo and Yo constituting the digital video signal DV as the data signal voltage, and applies the data signal voltage corresponding to the red primary color signal Ro to the data signal line connected to the R sub pixel forming portion 61r, applies the data signal voltage corresponding to the green primary color signal Go to the data signal line connected to the G sub pixel forming portion 61g, applies the data signal voltage corresponding to the blue primary color signal Bo to the data signal line connected to the B sub pixel forming portion 61b, and applies the data signal voltage corresponding to the yellow primary color signal Yo to the data signal line connected to the Y sub pixel forming portion 61y.

The scanning signal line drive circuit 14 sequentially applies an active scanning signal (scanning signal voltage) to the scanning signal line in the display portion 6 based on the gate start pulse signal GSP and the gate clock signal GCK output from the display control circuit 11.

As described above, at the display portion 6, the data signal voltage and the scanning signal voltage are respectively applied to the data signal line and the scanning signal line. Thereby, in the pixel capacity of each of the sub pixel forming portions 61r, 61g, 61b and 61y, voltage corresponding to the digital video signal DV is held to be applied to the liquid crystal layer, resulting in display of a color image indicated by the digital video signal DV on the display portion 6.

Note that, at this time, each R sub pixel forming portion 61r controls a transmission amount of red light correspondingly to voltage held in the pixel capacity inside thereof; each G sub pixel forming portion 61g controls a transmission amount of green light correspondingly to voltage held in the pixel capacity inside thereof; each B sub pixel forming portion 61b controls a transmission amount of blue light correspondingly to voltage held in the pixel capacity inside thereof; and each Y sub pixel forming portion 61y controls a transmission amount of yellow light correspondingly to voltage held in the pixel capacity inside thereof.

A main object of the present invention is to enable to perform accurate color reproduction with a simple method, when transforming three primary colors of input into four primary colors of output to display. For such a configuration, the liquid crystal display device is provided with a color transformation portion 12 which transforms RGB three primary colors of an input video signal into tri-stimulus values of an XYZ color system and transforms the transformed tri-stimulus values into four primary colors of an output video signal. The color transformation portion 12 fixes any one of color components of the four primary colors of the output video signal as well as obtains tri-stimulus value differences which are differences between tri-stimulus values of the RGB three primary colors of the input video signal and tri-stimulus values of the fixed color component, and transforms the obtained tri-stimulus value differences by a predefined inverse matrix into three color components other than the fixed color component.

Description will be given specifically for a processing example of the color transformation portion 12 based on FIG. 3. In the transformation from the input video signal RiGiBi into the tri-stimulus values XYZ, calculation is performed by a formula (1) below using a 3×3 matrix composed of tri-stimulus values of primary color points of the input video signal RiGiBi (X_{3R}, X_{3G}, . . . , Z_{3B}). Note that, each value constituting the 3×3 matrix of the formula (1) is determined depending on a type of the input video signal.

$$\begin{matrix}[ Expression 1 ] & \\ [ \begin{matrix}X \\ Y \\ Z\end{matrix} ] = [ \begin{matrix}{X}_{3 R} & {X}_{3 G} & {X}_{3 B} \\ {Y}_{3 R} & {Y}_{3 G} & {Y}_{3 B} \\ {Z}_{3 R} & {Z}_{3 G} & {Z}_{3 B}\end{matrix} ] [ \begin{matrix}{R}_{i} \\ {G}_{i} \\ {B}_{I}\end{matrix} ] & formula ( 1 )\end{matrix}$$

Furthermore, the tri-stimulus values XYZ calculated by the above-described formula (1) are transformed into the output video signal RoGoBoEo (color component Eo is yellow Yo, cyan Co or white Wo), in which any one of color components of the output video signal RoGoBoEo is fixed in the present invention. Note that, the input video signal RiGiBi and the output video signal RoGoBoEo are signals which have become linear by being subjected to inverse gamma (the same is applied below). Here, for example, when the color component Eo other than RGB is yellow Yo, calculation is performed by a formula (2) below using an inverse matrix of a 3×3 matrix composed of tri-stimulus values of primary color points of the output video signal RoGoBoEo (X_{4R}, X_{4G}, . . . , Z_{4E}). This example of the formula (2) shows a case where the red color component Ro of the output video signal RoGoBoEo is fixed.

$$\begin{matrix}[ Expression 2 ] & \\ \{ \begin{matrix}{R}_{o} = a \times {R}_{i} \\ [ \begin{matrix}{G}_{o} \\ {B}_{o} \\ {E}_{o}\end{matrix} ] = {[ \begin{matrix}{X}_{4 G} & {X}_{4 B} & {X}_{4 E} \\ {Y}_{4 G} & {Y}_{4 B} & {Y}_{4 E} \\ {Z}_{4 G} & {Z}_{4 B} & {Z}_{4 E}\end{matrix} ]}^{- 1} [ \begin{matrix}X - {X}_{4 R} \times {R}_{o} \\ Y - {Y}_{4 R} \times {R}_{o} \\ Z - {Z}_{4 R} \times {R}_{o}\end{matrix} ]\end{matrix} & formula ( 2 )\end{matrix}$$

A gray level value (0 to 255) of the fixed red color component Ro (hereinafter, referred to as the fixed red color component Ro) of the output video signal RoGoBoEo is a value obtained by multiplying a gray level value (0 to 255) of the same red color component Ri of the input video signal RiGiBi by a predetermined coefficient a (a>0). Note that, this coefficient a may be any of a constant, a variable and a function, but is set in a range of not exceeding the maximum gray level value 255 of the fixed red color component Ro. For example, if a=1, Ro=Ri. That is, the red color component Ro of the output video signal is fixed to the same gray level value as that of the red color component Ri of the input video signal.

Moreover, the inverse matrix in the formula (2) is an inverse matrix of a 3×3 matrix composed of tri-stimulus values (X_{4G}, X_{4B}, . . . , Z_{4E}) of the three primary colors GoBoEo excluding the fixed red color component Ro from the four primary colors of the output video signal RoGoBoEo. Note that, each value of X_{4R}, X_{4G}, X_{4B}, X_{4E}, Y_{4R}, Y_{4G}, Y_{4B}, Y_{4E}, Z_{4R}, Z_{4G}, Z_{4B}, and Z_{4E} in the formula (2) is determined based on characteristics of a display panel of the liquid crystal display device and the same is applied to the formula (3) to formula (13) below.

Further, tri-stimulus value differences which are differences between the tri-stimulus values (X, Y, Z) of the input video signal RiGiBi and tri-stimulus values of the fixed red color component Ro (X_{4R}×Ro, Y_{4R}×Ro, Z_{4R}×Ro) (X−X_{4R}×Ro, Y−Y_{4R}×Ro, Z−Z_{4R}×Ro) are obtained, and the obtained tri-stimulus value differences (X−X_{4R}×Ro, Y−Y_{4R}×Ro, Z−Z_{4R}×Ro) are transformed into three color components (Go, Bo, Eo) other than the fixed red color component Ro by the above-described inverse matrix (X_{4G}, X_{4B}, . . . , Z_{4E}).

In this manner, by fixing the red color component of the four color signals of output, it is possible to perform a 3×3 matrix operation with the remaining three colors, thus making it possible to transform the tri-stimulus values XYZ of the three color signals of input into the four color signals of output easily.

An example of the formula (3) below shows a case where the green color component Go of the output video signal RoGoBoEo is fixed. Note that, the color component Eo other than RGB is, for example, yellow Yo or cyan Co.

$$\begin{matrix}[ Expression 3 ] & \\ \{ \begin{matrix}{G}_{o} = a \times {G}_{i} \\ [ \begin{matrix}{R}_{o} \\ {B}_{o} \\ {E}_{o}\end{matrix} ] = {[ \begin{matrix}{X}_{4 R} & {X}_{4 B} & {X}_{4 E} \\ {Y}_{4 R} & {Y}_{4 B} & {Y}_{4 E} \\ {Z}_{4 R} & {Z}_{4 B} & {Z}_{4 E}\end{matrix} ]}^{- 1} [ \begin{matrix}X - {X}_{4 G} \times {G}_{o} \\ Y - {Y}_{4 G} \times {G}_{o} \\ Z - {Z}_{4 G} \times {G}_{o}\end{matrix} ]\end{matrix} & formula ( 3 )\end{matrix}$$

A gray level value (0 to 255) of the fixed green color component Go (hereinafter, referred to as the fixed green color component Go) of the output video signal RoGoBoEo is a value obtained by multiplying a gray level value (0 to 255) of the same green color component Gi of the input video signal RiGiBi by a predetermined coefficient a (>0). Note that, this coefficient a may be any of a constant, a variable and a function, but is set in a range of not exceeding the maximum gray level value 255 of the fixed green color component Go. For example, if a=1, Go=Gi. That is, the green color component Go of the output video signal is fixed to the same gray level value as that of the green color component Gi of the input video signal.

Moreover, the inverse matrix in the formula (3) is an inverse matrix of a 3×3 matrix composed of tri-stimulus values (X_{4R}, X_{4B}, . . . , Z_{4E}) of the three primary colors RoBoEo excluding the fixed green color component Go from the four primary colors of the output video signal RoGoBoEo.

Further, tri-stimulus value differences which are differences between the tri-stimulus values (X, Y, Z) of the input video signal RiGiBi and tri-stimulus values of the fixed green color component Go (X_{4G}×Go, Y_{4G}×Go, Z_{4G}×Go) (X−X_{4G}×Go, Y−Y_{4G}×Go, Z−Z_{4G}×Go) are obtained, and the obtained tri-stimulus value differences (X−X_{4G}×Go, Y−Y_{4G}×Go, Z−Z_{4G}×Go) are transformed into three color components (Ro, Bo, Eo) other than the fixed green color component Go by the above-described inverse matrix (X_{4R}, X_{4B}, . . . , Z_{4E}).

In this manner, by fixing the green color component of the four color signals of output, it is possible to perform a 3×3 matrix operation with the remaining three colors, thus making it possible to transform the tri-stimulus values XYZ of the three color signals of input into the four color signals of output easily.

An example of a formula (4) below shows a case where the blue color component Bo of the output video signal RoGoBoEo is fixed. Note that, the color component Eo other than RGB is, for example, cyan Co.

$$\begin{matrix}[ Expression 4 ] & \\ \{ \begin{matrix}{B}_{o} = a \times {B}_{i} \\ [ \begin{matrix}{R}_{o} \\ {B}_{o} \\ {E}_{o}\end{matrix} ] = {[ \begin{matrix}{X}_{4 R} & {X}_{4 G} & {X}_{4 E} \\ {Y}_{4 R} & {Y}_{4 G} & {Y}_{4 E} \\ {Z}_{4 R} & {Z}_{4 G} & {Z}_{4 E}\end{matrix} ]}^{- 1} [ \begin{matrix}X - {X}_{4 B} \times {B}_{o} \\ Y - {Y}_{4 B} \times {B}_{o} \\ Z - {Z}_{4 B} \times {B}_{o}\end{matrix} ]\end{matrix} & formula ( 4 )\end{matrix}$$

A gray level value (0 to 255) of the fixed blue color component Bo (hereinafter, referred to as the fixed blue color component Bo) of the output video signal RoGoBoEo is a value obtained by multiplying a gray level value (0 to 255) of the same blue color component Bi of the input video signal RiGiBi by a predetermined coefficient a (a>0). Note that, this coefficient a may be any of a constant, a variable and a function, but is set in a range of not exceeding the maximum gray level value 255 of the fixed blue color component Bo. For example, if a=1, Bo=Bi. That is, the blue color component Bo of the output video signal is fixed to the same gray level value as that of the blue color component Bi of the input video signal.

Moreover, the inverse matrix in the formula (4) is an inverse matrix of a 3×3 matrix composed of tri-stimulus values (X_{4R}, X_{4G}, . . . , Z_{4E}) of the three primary colors RoGoEo excluding the fixed blue color component Bo from the four primary colors of the output video signal RoGoBoEo.

Further, tri-stimulus value differences which are differences between the tri-stimulus values (X, Y, Z) of the input video signal RiGiBi and tri-stimulus values of the fixed blue color component Bo (X_{4B}×Bo, Y_{4B}×Bo, Z_{4B}×Bo) (X−X_{4B}×Bo, Y−Y_{4B}×Bo, Z−Z_{4B}×Bo) are obtained, and the obtained tri-stimulus value differences (X−X_{4B}×Bo, Y−Y_{4B}×Bo, Z−Z_{4B}×Bo) are transformed into three color components (Ro, Go, Eo) other than the fixed blue color component Bo by the above-described inverse matrix (X_{4R}, X_{4G}, . . . , Z_{4E}).

In this manner, by fixing the blue color component of the four color signals of output, it is possible to perform a 3×3 matrix operation with the remaining three colors, thus making it possible to transform the tri-stimulus values XYZ of the three color signals of input into the four color signals of output easily.

Though any one color of the red color component Ro, the green color component Go and the blue color component Bo of the output video signal RoGoBoEo is fixed above, the color component Eo other than the RGB three primary colors may be fixed. Examples of formulas (5) and (6) below show cases where the color component Eo other than the RGB three primary colors of the output video signal RoGoBoEo is fixed. Note that, the color component Eo other than RGB is, for example, white Wo.

$$\begin{matrix}[ Expression 5 ] & \\ \{ \begin{matrix}{E}_{o} = a \times min ( {R}_{i} , {G}_{i} , {B}_{i} ) \\ [ \begin{matrix}{R}_{o} \\ {G}_{o} \\ {B}_{o}\end{matrix} ] = {[ \begin{matrix}{X}_{4 R} & {X}_{4 G} & {X}_{4 B} \\ {Y}_{4 R} & {Y}_{4 G} & {Y}_{4 B} \\ {Z}_{4 R} & {Z}_{4 G} & {Z}_{4 B}\end{matrix} ]}^{- 1} [ \begin{matrix}X - {X}_{4 E} \times {E}_{o} \\ Y - {Y}_{4 E} \times {E}_{o} \\ Z - {Z}_{4 E} \times {E}_{o}\end{matrix} ]\end{matrix} & formula ( 5 ) \\ or & \\ \{ \begin{matrix}{E}_{o} = a \times max ( {R}_{i} , {G}_{i} , {B}_{i} ) \\ [ \begin{matrix}{R}_{o} \\ {G}_{o} \\ {B}_{o}\end{matrix} ] = {[ \begin{matrix}{X}_{4 R} & {X}_{4 G} & {X}_{4 B} \\ {Y}_{4 R} & {Y}_{4 G} & {Y}_{4 B} \\ {Z}_{4 R} & {Z}_{4 G} & {Z}_{4 B}\end{matrix} ]}^{- 1} [ \begin{matrix}X - {X}_{4 E} \times {E}_{o} \\ Y - {Y}_{4 E} \times {E}_{o} \\ Z - {Z}_{4 E} \times {E}_{o}\end{matrix} ]\end{matrix} & formula ( 6 )\end{matrix}$$

A gray level value (0 to 255) of the fixed color component Eo (hereinafter, referred to as the fixed color component Eo) of the output video signal RoGoBoEo is a value obtained by multiplying a minimum (formula 5) or maximum (formula 6) gray level value (0 to 255) of the RGB three primary colors of the input video signal RiGiBi by a predetermined coefficient a (>0). Note that, this coefficient a may be any of a constant, a variable and a function, but is set in a range of not exceeding the maximum gray level value 255 of the fixed color component Eo. For example, if a=1, Eo=min (Ri, Gi, Bi) or max (Ri, Gi, Bi). That is, the color component Eo of the output video signal is fixed to the same gray level value as the minimum gray level value or the maximum gray level value of the RGB three primary colors of the input video signal.

Moreover, the inverse matrixes in the formula (5) and the formula (6) are inverse matrixes of a 3×3 matrix composed of tri-stimulus values (X_{4R}, X_{4G}, . . . , Z_{4E}) of three primary colors RoGoBo excluding the fixed color component Eo from the four primary colors of the output video signal RoGoBoEo.

Further, tri-stimulus value differences which are differences between the tri-stimulus values (X, Y, Z) of the input video signal RiGiBi and tri-stimulus values of the fixed color component Eo (X_{4E}×Eo, Y_{4E}×Eo, Z_{4E}×Eo) (X−X_{4E}×Eo, Y−Y_{4E}×Eo, Z−Z_{4E}×Eo) are obtained, and the obtained tri-stimulus value differences (X−X_{4E}×Eo, Y−Y_{4E}×Eo, Z−Z_{4E}×Eo) are transformed into three color components (Ro, Go, Bo) other than the fixed color component Eo by the above-described inverse matrix (X_{4R}, X_{4G}, . . . , Z_{4B}).

In this manner, by fixing the color component other than the RGB three primary colors of the four color signals of output, it is possible to perform a 3×3 matrix operation with the remaining three colors, thus making it possible to transform the tri-stimulus values XYZ of the three color signals of input into the four color signals of output easily.

Here, it is possible to determine the color component to be fixed depending on what to be set for the fourth color component other than RGB. For example, when yellow is set to the fourth color (Eo), red or green is fixed, when cyan is set to the fourth color (Eo), green or blue is fixed, or when white is set to the fourth color (Eo), white is fixed. Because of performing simple matrix calculation in the present invention, there is a case where a calculation result of an output signal is less than 0 or exceeds 255 depending on a way of selecting the fixed color. Thus, when the calculation of the output signal was performed by varying the fixed color for each case where the fourth color is set to yellow, cyan or white, it was found that the calculation result was hard to be saturated by determining the fixed color as described above. Note that, when the fourth color is set to white, any of RGB may be fixed, but white is preferably fixed for such a reason.

Description will be given for a working example when the output video signal is set to RoGoBoYo (four primary colors of red, green, blue and yellow). As a first example, there is a method for not changing the fixed color of the output video signal. In this case, the color transformation portion 12 fixes either the red color component Ro or the green color component Go of the output video signal. A matrix operation when the red color component Ro is fixed is performed with a formula (7).

$$\begin{matrix}[ Expression 6 ] & \\ \{ \begin{matrix}{R}_{o} = a \times {R}_{i} \\ [ \begin{matrix}{G}_{o} \\ {B}_{o} \\ {Y}_{o}\end{matrix} ] = {[ \begin{matrix}{X}_{4 G} & {X}_{4 B} & {X}_{4 Y} \\ {Y}_{4 G} & {Y}_{4 B} & {Y}_{4 Y} \\ {Z}_{4 G} & {Z}_{4 B} & {Z}_{4 Y}\end{matrix} ]}^{- 1} [ \begin{matrix}X - {X}_{4 R} \times {R}_{o} \\ Y - {Y}_{4 R} \times {R}_{o} \\ Z - {Z}_{4 R} \times {R}_{o}\end{matrix} ]\end{matrix} & formula ( 7 )\end{matrix}$$

Note that, as a specific example of the coefficient a, when the gray level value of the red color component Ri> the gray level value of the green color component Gi,

a=1,and

when the gray level value of the red color component Ri≦ the gray level value of the green color component Gi,

a=1−(Gi−Ri)*b/Gi,

in which Gi and Ri are input gray level values and b is a constant.

Moreover, as a second example, the fixed color of the output video signal may be changed depending on a magnitude relation of the gray level of the red color component Ri and the gray level of the green color component Gi of the input video signal. In this case, the control portion 4 compares the gray level value of the red color component Ri and the gray level value of the green color component Gi of the input video signal RiGiBi, and when the gray level value of the red color component Ri> the gray level value of the green color component Gi, the color transformation portion 12 fixes the red color component Ro of the output video signal. The matrix operation at this time is performed with a formula (8). Further, when the gray level value of the red color component Ri≦ the gray level value of the green color component Gi, the color transformation portion 12 fixes the green color component Go of the output video signal. The matrix operation at this time is performed with a formula (9). Note that, coefficients a₁ and a₂ in the formulas (8) and (9) may be any of a constant, a variable and a function as described above.

$$\begin{matrix}[ Expression 7 ] & \\ when {R}_{i} > {G}_{i} \\ \{ \begin{matrix}{R}_{o} = {a}_{1} \times {R}_{i} \\ [ \begin{matrix}{G}_{o} \\ {B}_{o} \\ {Y}_{o}\end{matrix} ] = {[ \begin{matrix}{X}_{4 G} & {X}_{4 B} & {X}_{4 Y} \\ {Y}_{4 G} & {Y}_{4 B} & {Y}_{4 Y} \\ {Z}_{4 G} & {Z}_{4 B} & {Z}_{4 Y}\end{matrix} ]}^{- 1} [ \begin{matrix}X - {X}_{4 R} \times {R}_{o} \\ Y - {Y}_{4 R} \times {R}_{o} \\ Z - {Z}_{4 R} \times {R}_{o}\end{matrix} ]\end{matrix} & formula ( 8 ) \\ when {R}_{i} ≦ {G}_{i} & \\ \{ \begin{matrix}{G}_{o} = {a}_{2} \times {G}_{i} \\ [ \begin{matrix}{R}_{o} \\ {B}_{o} \\ {Y}_{o}\end{matrix} ] = {[ \begin{matrix}{X}_{4 R} & {X}_{4 B} & {X}_{4 Y} \\ {Y}_{4 R} & {Y}_{4 B} & {Y}_{4 Y} \\ {Z}_{4 R} & {Z}_{4 B} & {Z}_{4 Y}\end{matrix} ]}^{- 1} [ \begin{matrix}X - {X}_{4 G} \times {G}_{o} \\ Y - {Y}_{4 G} \times {G}_{o} \\ Z - {Z}_{4 G} \times {G}_{o}\end{matrix} ]\end{matrix} & formula ( 9 )\end{matrix}$$

Next, description will be given for a working example when the output video signal is set to RoGoBoCo (four primary colors of red, green, blue and cyan). As a first example, there is a method for not changing the fixed color of the output video signal. In this case, the color transformation portion 12 fixes either the green color component Go or the blue color component Bo of the output video signal. A matrix operation when the blue color component Bo is fixed is performed with a formula (10).

$$\begin{matrix}[ Expression 8 ] & \\ \{ \begin{matrix}{B}_{o} = a \times {B}_{i} \\ [ \begin{matrix}{R}_{o} \\ {G}_{o} \\ {C}_{o}\end{matrix} ] = {[ \begin{matrix}{X}_{4 R} & {X}_{4 G} & {X}_{4 C} \\ {Y}_{4 R} & {Y}_{4 G} & {Y}_{4 C} \\ {Z}_{4 R} & {Z}_{4 G} & {Z}_{4 C}\end{matrix} ]}^{- 1} [ \begin{matrix}X - {X}_{4 B} \times {B}_{o} \\ Y - {Y}_{4 B} \times {B}_{o} \\ Z - {Z}_{4 B} \times {B}_{o}\end{matrix} ]\end{matrix} & formula ( 10 )\end{matrix}$$

Note that, as a specific example of the coefficient a, when the gray level value of the blue color component Bi> the gray level value of the green color component Gi,

a=1,and

when the gray level value of the blue color component Bi the gray level value of the green color component Gi,

a=1−(Gi−Bi)*b/Gi,

in which Gi and Bi are input gray level values and b is a constant.

Moreover, as a second example, the fixed color of the output video signal may be changed depending on a magnitude relation of the gray level of the green color component Gi and the gray level of the blue color component Bi of the input video signal. In this case, the control portion 4 compares the gray level value of the green color component Gi and the gray level value of the blue color component Bi of the input video signal RiGiBi, and when the gray level value of the green color component Gi> the gray level value of the blue color component Bi, the color transformation portion 12 fixes the green color component Go of the output video signal. The matrix operation at this time is performed with a formula (11). Further, when the gray level value of the green color component Gi≦ the gray level value of the blue color component Bi, the color transformation portion 12 fixes the blue color component Bo of the output video signal. The matrix operation at this time is performed with a formula (12). Note that, coefficients a₁ and a₂ in the formulas (11) and (12) may be any of a constant, a variable and a function as described above.

$$\begin{matrix}[ Expression 9 ] & \\ when {G}_{i} > {B}_{i} \\ \{ \begin{matrix}{G}_{o} = {a}_{1} \times {G}_{i} \\ [ \begin{matrix}{R}_{o} \\ {B}_{o} \\ {C}_{o}\end{matrix} ] = {[ \begin{matrix}{X}_{4 R} & {X}_{4 B} & {X}_{4 C} \\ {Y}_{4 R} & {Y}_{4 B} & {Y}_{4 C} \\ {Z}_{4 R} & {Z}_{4 B} & {Z}_{4 C}\end{matrix} ]}^{- 1} [ \begin{matrix}X - {X}_{4 G} \times {G}_{o} \\ Y - {Y}_{4 G} \times {G}_{o} \\ Z - {Z}_{4 G} \times {G}_{o}\end{matrix} ]\end{matrix} & formula ( 11 ) \\ when {G}_{i} ≦ {B}_{i} & \\ \{ \begin{matrix}{B}_{o} = {a}_{2} \times {B}_{i} \\ [ \begin{matrix}{R}_{o} \\ {G}_{o} \\ {C}_{o}\end{matrix} ] = {[ \begin{matrix}{X}_{4 R} & {X}_{4 G} & {X}_{4 C} \\ {Y}_{4 R} & {Y}_{4 G} & {Y}_{4 C} \\ {Z}_{4 R} & {Z}_{4 G} & {Z}_{4 C}\end{matrix} ]}^{- 1} [ \begin{matrix}X - {X}_{4 B} \times {B}_{o} \\ Y - {Y}_{4 B} \times {B}_{o} \\ Z - {Z}_{4 B} \times {B}_{o}\end{matrix} ]\end{matrix} & formula ( 12 )\end{matrix}$$

Next, description will be given for a working example when the output video signal is set to RoGoBoWo (four primary colors of red, green, blue and white). In this case, the control portion 4 judges a magnitude relation of each gray level of the RGB three primary colors in the input video signal RiGiBi, and the color transformation portion 12 fixes a white color component Wo (Wo≦255) of the output video signal to a value obtained by multiplying a minimum gray level value in these RGB three primary colors, for example, by a coefficient a (a>0) based on this judgment result. The matrix operation at this time is performed with a formula (13). Note that, the coefficient a in the formula (13) may be any of a constant, a variable and a function as described above.

$$\begin{matrix}[ Expression 10 ] & \\ \{ \begin{matrix}{W}_{o} = a \times min ( {R}_{i} , {G}_{i} , {B}_{i} ) \\ [ \begin{matrix}{R}_{o} \\ {G}_{o} \\ {B}_{o}\end{matrix} ] = {[ \begin{matrix}{X}_{4 R} & {X}_{4 G} & {X}_{4 B} \\ {Y}_{4 R} & {Y}_{4 G} & {Y}_{4 B} \\ {Z}_{4 R} & {Z}_{4 G} & {Z}_{4 B}\end{matrix} ]}^{- 1} [ \begin{matrix}X - {X}_{4 W} \times {W}_{o} \\ Y - {Y}_{4 W} \times {W}_{o} \\ Z - {Z}_{4 W} \times {W}_{o}\end{matrix} ]\end{matrix} & formula ( 13 )\end{matrix}$$

Note that, as a specific example of the coefficient a,

a=(Y_{4R}+Y_{4G}+Y_{4B}+Y_{4W})/Y_{4W},

in which Y is a stimulus value of a color.

Note that, since a merit of using a white pixel is improvement of luminance efficiency, it is necessary to prevent saturation of the gray level while using the white pixel as many as possible. This example is one method therefor. Of course, the calculation may be performed only with the gray level like the examples of RoGoBoYo and RoGoBoCo, the calculation may be performed using a luminance ratio of each color.

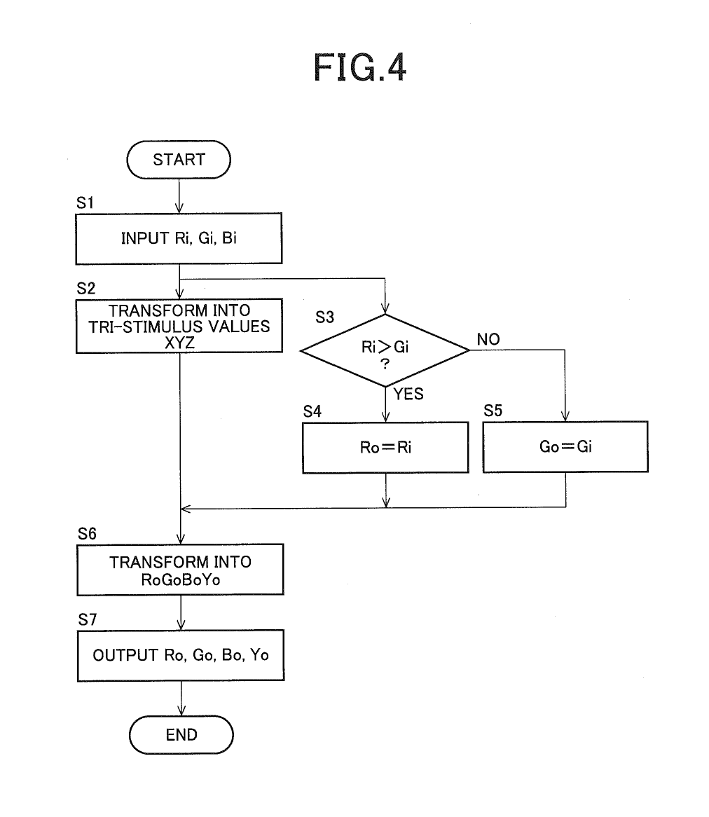

FIG. 4 is a flowchart explaining one example of color transformation processing from RGB into RGBY. First, when a video signal RiGiBi composed of RGB three colors is input (step S1), the color transformation portion 12 transforms this input video signal RiGiBi into tri-stimulus values XYZ of an XYZ color system in accordance with the formula (1) described above (step S2). In addition, the control portion 4 compares the gray level value of the red color component Ri and the gray level value of the green color component Gi included in the input video signal RiGiBi (step S3).

Further, when judging that the gray level value of the red color component Ri is larger than the gray level value of the green color component Gi (in the case of YES at step S3), the control portion 4 notifies the color transformation portion 12 of this judgment result, and, upon the notification from the control portion 4, the color transformation portion 12 fixes the gray level value of the red color component Ro of the output video signal RoGoBoEo to the same value as the gray level value of the red color component Ri of the input video signal RiGiBi in accordance with the formula (8) described above (step S4). Note that, it is set that the coefficient a₁ of the formula (8)=1 here.

Further, when judging that the gray level value of the red color component Ri is not larger than the gray level value of the green color component Gi (in the case of NO at step S3), the control portion 4 notifies the color transformation portion 12 of this judgment result, and, upon the notification from the control portion 4, the color transformation portion 12 fixes the gray level value of the green color component Go of the output video signal RoGoBoEo to the same value as the gray level value of the green color component Gi of the input video signal RiGiBi in accordance with the formula (9) described above (step S5). Note that, it is set that the coefficient a₂ of the formula (9)=1 here.

Next, when the red color component Ro is fixed, the color transformation portion 12 obtains tri-stimulus value differences which are differences between tri-stimulus values (X, Y, Z) of the input video signal RiGiBi and tri-stimulus values of the fixed red color component Ro (X_{4R}×Ro, Y_{4R}×Ro, Z_{4R}×Ro) (X−X_{4R}×Ro, Y−Y_{4R}×Ro, Z−Z_{4R}×Ro), and transforms the obtained tri-stimulus value differences (X−X_{4R}×Ro, Y−Y_{4R}×Ro, Z−Z_{4R}×Ro) into three color components (Go, Bo, Yo) other than the fixed red color component Ro by an inverse matrix of 3×3 (X_{4G}, X_{4B}, . . . , Z_{4Y}) in accordance with the formula (8) (step S6). Note that, when the green color component Go is fixed, the same calculation is performed in accordance with the formula (9).

Then, the color transformation portion 12 outputs the video signal RoGoBoYo that is transformed at step S6 (step S7). In this manner, when RGB is transformed into RGBY, by fixing the R component or the G component among RGBY, it is possible to perform a 3×3 matrix operation with the remaining three colors, thus making it possible to transform the tri-stimulus values XYZ of the RGB signals of input into the RGBY signals of output easily.

### Second Embodiment

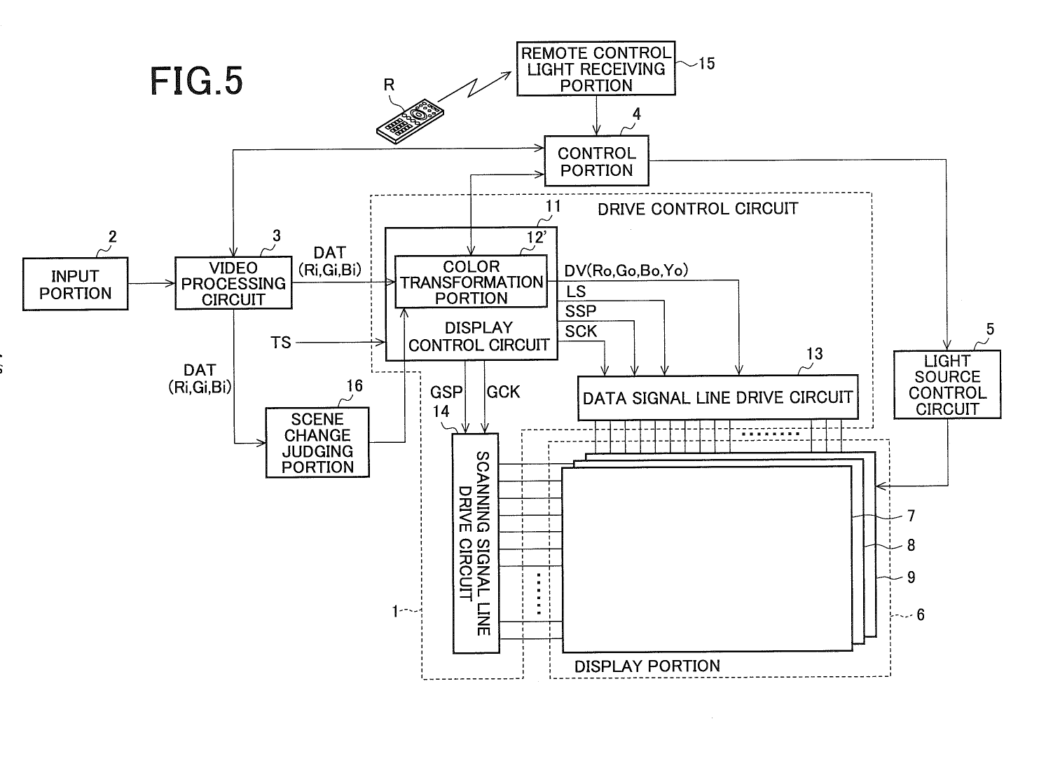

FIG. 5 is a block diagram showing a configuration example of a display device according to a second embodiment of the present invention, and in the diagram, 12′ denotes a color transformation portion and 16 denotes a scene change judging portion. Though the fixed color is basically determined by pixel in the first embodiment described above, the fixed color may be determined by frame. That is, in the case of color transformation from RGB into RGBY, the color transformation portion 12′ judges which of the gray level value of the red color component Ri and the gray level value of the green color component Gi of the input video signal is larger for each frame of the input video signal RiGiBi, and based on a judgment result, fixes the red color component Ro or the green color component Go for each frame of the output video signal RoGoBo.

In the above, in the case of seeing as an image of one frame, if the color to be fixed is different for each pixel, for example, when a gradational video or the like is seen from an oblique direction, there is a case where the color is felt to be discontinuous by a viewer. For example, at a time of fixing R or G based on a magnitude relation of the gray level value of the red color component Ri and the gray level value of the green color component Gi, when the color gradually changes from cyan to magenta, G becomes the fixed color in a cyan side and R becomes the fixed color in a magenta side, so that there is a case where the color becomes discontinuous near an intermediate color between both of them. To improve it, which of the red color component Ri and the green color component Gi of the image of one frame is dominant is judged, and the fixed color is determined by frame based on this judgment result.

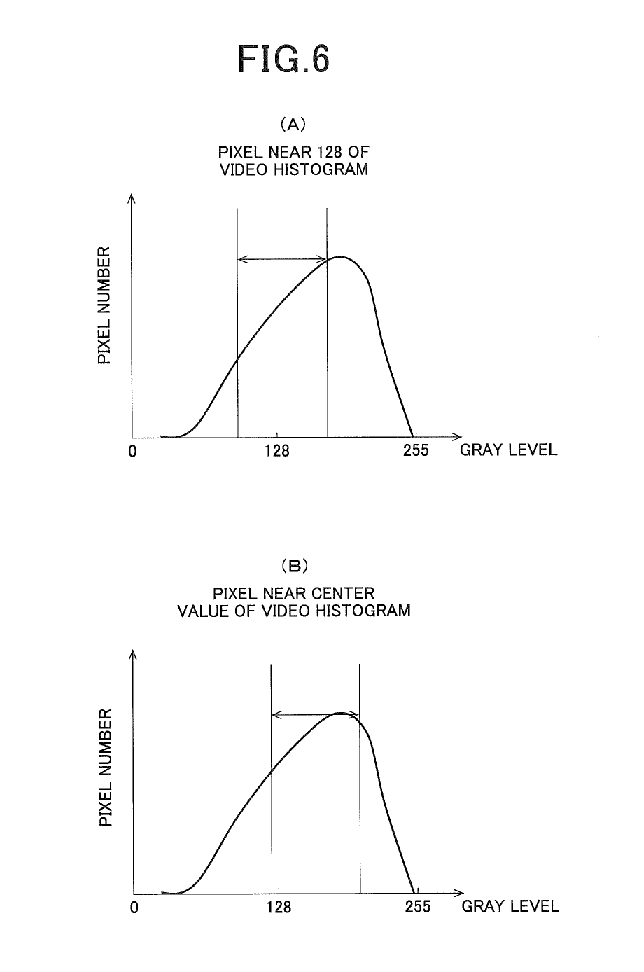

More specifically, as a first method, the number of pixels in which the gray level value of the red color component Ri is larger than the gray level value of the green color component Gi and the number of pixels in which the gray level value of the green color component Gi is larger than the gray level value of the red color component Ri are counted for all pixels of one frame, and the color component (R or G) having a larger count value is set to the fixed color. Further, as a second method, a sum of the gray level values of the red color components Ri and a sum of the gray level values of the green color components Gi are calculated for all pixels of one frame, and the color component (R or G) having a larger sum value may be set to the fixed color. In addition, as a third method, the first method or the second method described above may be executed for a pixel in a halftone area where color is easily expressed. Specifically, the first method or the second method is executed for a pixel near the 128th gray level of 0 to 255th gray level of a video histogram as shown in FIG. 6(A) and a pixel near a center value of the video histogram as shown in FIG. 6(B).

Further, as still another embodiment, it is also considered not to change the fixed color during a consecutive scene. When continuity of a color is desired to be ensured in a moving image or the like, the fixed color may be determined in a head frame of a series of scenes, and then, the fixed color may be kept as it is until the scenes change. That is, when color transformation is performed from RGB into RGBY, the liquid crystal display device is provided with the scene change judging portion 16 that judges scene change based on a feature amount of an input video signal RiGiBi, and the color transformation portion 12′ judges which of the gray level value of the red color component Ri and the gray level value of the green color component Gi of the input video signal is larger as to the head frame in which scene change is judged by the scene change judging portion 16 and keeps the red or green fixed based on a judgment result until next scene change occurs.

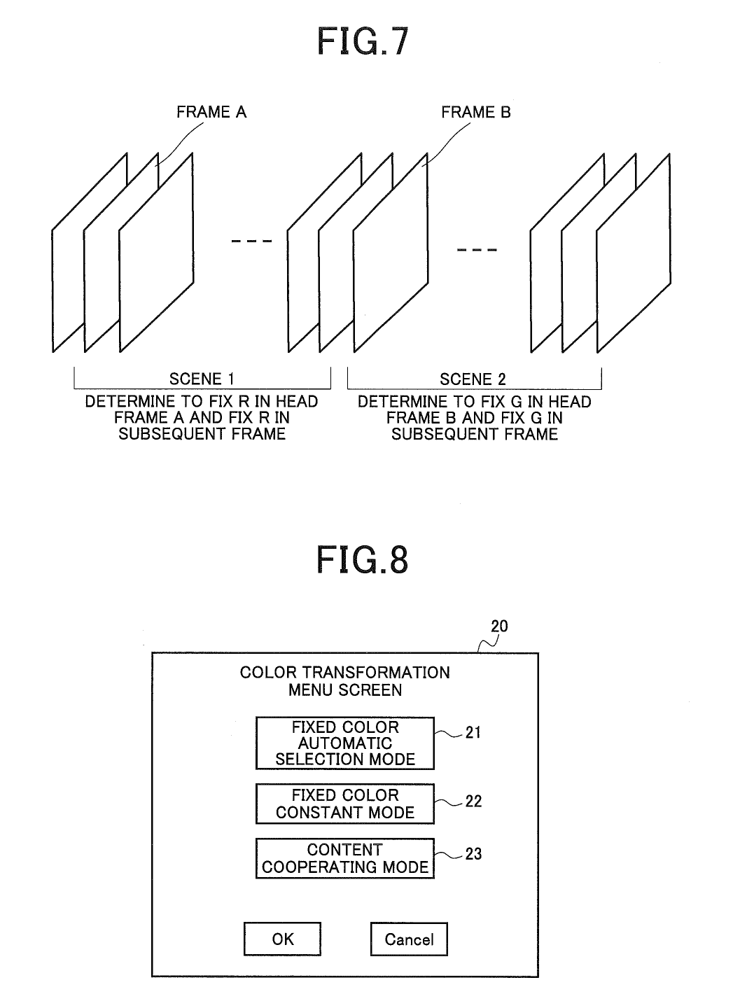

In FIG. 7, when there are a series of a scene 1 and a scene 2, the red R is determined as the fixed color in a head frame A of the scene 1 and the red R is fixed as it is in a subsequent frame included in the scene 1. Moreover, the green G is determined as the fixed color in a head frame B of the scene 2 and the green G is fixed as it is in a subsequent frame included in the scene 2. Note that, examples of the above-described feature amount of the input video signal RiGiBi include an APL (Average Picture Level) of the input video signal RiGiBi or the like. This makes it possible to perform color transformation according to shades of the scene as well as to keep continuity of a color during a series of scenes.

Moreover, in a program which has been already recorded, which of the red R and the green G is dominant may be judged for a video of the program before playing to determine the fixed color according to a judgment result. In this case, it is desirable because it is possible to perform appropriate color transformation as the entire scene.

Here, though description has been given above by exemplifying color transformation from RGB into RGBY, the same processing is possible even for color transformation from RGB into RGBC. In this case, the fixed color is neither the red R nor the green G, but is the green G or the blue B.

FIG. 8 is a diagram showing one example of a color transformation menu screen, and 20 denotes a color transformation menu screen in the diagram. The color transformation menu screen 20 has a fixed color automatic selection mode 21, a fixed color constant mode 22, and a content cooperating mode 23. With an operation of a user, by displaying the color transformation menu screen 20 on the display portion 6, selecting a desired mode from the color transformation menu screen 20, and pressing an “OK” button, a mode is set. Note that, when a “Cancel” button is pressed, the color transformation menu screen 20 is cleared.

Though description will be given below by exemplifying a case of color transformation from RGB into RGBY, the same is applied even for color transformation from RGB into RGBC. The fixed color automatic selection mode 21 is a mode in which the fixed color is automatically selected depending on a magnitude relation of the red R or the green G. The fixed color constant mode 22 is a mode in which the fixed color of the red R or the green G is always made constant. When this fixed color constant mode 22 is set, it is not possible to perform color transformation adaptively depending on a video, but a tone will not change subtly depending on the video. Moreover, when the fixed color automatic selection mode 21 is set, it is possible to perform color transformation suitable for four colors.

In addition, the content cooperating mode 23 is a mode in which the fixed color automatic selection mode 21 and the fixed color constant mode 22 are switched depending on content of video content. For example, in video content in which an effect of four colors is desired to be enjoyed (such as a movie, a painting, or landscape), it is switched to the fixed color automatic selection mode 21, and in video content in which an effect of four colors is not particularly necessary (such as a PC, news, or sports), it is switched to the fixed color constant mode. Note that, the PC is Web data, application data or the like that is input from a personal computer. The content of the video content may be obtained from genre information included in a broadcast signal or the like, or content of the video content may be input by the user. In this manner, by allowing the user to select mode setting from the color transformation menu screen, it is possible to perform color transformation according to preference of the user.

### EXPLANATIONS OF LETTERS OR NUMERALS

1 . . . drive control circuit, 2 . . . input portion, 3 . . . video processing circuit, 4 . . . control portion, 5 . . . light source control circuit, 6 . . . display portion, 7 . . . color filter, 8 . . . liquid crystal panel main body, 9 . . . backlight light source, 11 . . . display control circuit, 12, 12′ . . . color transformation portion, 13 . . . data signal line drive circuit, 14 . . . scanning signal line drive circuit, 15 . . . remote control light receiving portion, 16 . . . scene change judging portion, and 20 . . . color transformation menu screen.

1. A display device which transforms an input video signal of RGB three primary colors composed of red, green and blue into an output video signal of four primary colors to display, comprising:
a color transformation portion which transforms the RGB three primary colors of the input video signal into tri-stimulus values of an XYZ color system and transforms the transformed tri-stimulus values into the four primary colors of the output video signal, wherein
the color transformation portion fixes any one of color components of the four primary colors of the output video signal as well as obtains tri-stimulus value differences which are differences between the tri-stimulus values of the RGB three primary colors of the input video signal and tri-stimulus values of the fixed color component, and transforms the obtained tri-stimulus value differences by a predefined inverse matrix into three color components other than the fixed color component.

2. The display device according to claim 1, wherein the predefined inverse matrix is an inverse matrix of a 3×3 matrix composed of tri-stimulus values of the three primary colors excluding the fixed color component from the four primary colors of the output video signal.

3. The display device according to claim 1, wherein, in a case where any one of color components of the RGB three primary colors of the output video signal is fixed, a gray level value of the fixed color component of the output video signal is a value obtained by multiplying a gray level value of a same color component of the input video signal by a predetermined coefficient a (a>0).

4. The display device according to claim 3, wherein the four primary colors of the output video signal are RGBY four primary colors composed of red, green, blue and yellow.

5. The display device according to claim 4, wherein the color transformation portion fixes red or green of the output video signal.

6. The display device according to claim 5, wherein, in a case where a gray level value of red of the input video signal is larger than a gray level value of green, the color transformation portion fixes red of the output video signal.

7. The display device according to claim 5, wherein, in a case where a gray level value of red of the input video signal is equal to or less than a gray level value of green, the color transformation portion fixes green of the output video signal.

8. The display device according to claim 5, wherein the color transformation portion judges which of a gray level value of red and a gray level value of green of the input video signal is larger for each frame of the input video signal, and based on a judgment result, fixes red or green for each frame of the output video signal.

9. The display device according to claim 5, wherein a scene change judging portion which judges scene change based on a feature amount of the input video signal is included, and the color transformation portion judges which of a gray level value of red and a gray level value of green of the input video signal is larger as to a head frame in which scene change is judged by the scene change judging portion and keeps red or green fixed based on a judgment result until next scene change occurs.

10. The display device according to claim 3, wherein the four primary colors of the output video signal are RGBC four primary colors composed of red, green, blue and cyan.

11. The display device according to claim 10, wherein the color transformation portion fixes green or blue of the output video signal.

12. The display device according to claim 11, wherein, in a case where a gray level value of green of the input video signal is larger than a gray level value of blue, the color transformation portion fixes green of the output video signal.

13. The display device according to claim 11, wherein, in a case where a gray level value of green of the input video signal is equal to or less than a gray level value of blue, the color transformation portion fixes blue of the output video signal.

14. The display device according to claim 1, wherein, in a case where a color component other than the RGB three primary colors of the output video signal is fixed, a gray level value of the fixed color component of the output video signal is a value obtained by multiplying a minimum or maximum gray level value of the RGB three primary colors of the input video signal by a predetermined coefficient a (a>0).

15. The display device according to claim 14, wherein the four primary colors of the output video signal are RGBW four primary colors composed of red, green, blue and white.

16. The display device according to claim 15, wherein the color transformation portion fixes white of the output video signal.

17. A display device which transforms an input video signal of RGB three primary colors composed of red, green and blue into an output video signal of four primary colors composed of red, green, blue and yellow to display, wherein
in a case where a gray level value of red of the input video signal is larger than a gray level value of green, a gray level value of red of the output video signal is set as the gray level value of red of the input video signal, and
in a case where the gray level value of red of the input video signal is equal to or less than the gray level value of green, a gray level value of green of the output video signal is set as the gray level value of green of the input video signal, and
transformation is performed so that tri-stimulus values of the input video signal and the output video signal become equal.
